(19) United States
(12) Patent Application Publication
(10) Pub. No.: US 2020/0096304 A1
(43) Pub. Date: Mar. 26, 2020

(54) Electrical Measuring Device

(71) Applicant: Gary Potter, Austell, GA (US)

(72) Inventor: Gary Potter, Austell, GA (US)

(21) Appl. No.: 16/578,459

(22) Filed: Sep. 23, 2019

Related U.S. Application Data
(60) Provisional application No. 62/736,524, filed on Sep. 26, 2018.

(51) Int. Cl. G01B 3/04; G01B 3/00

(52) U.S. Cl. CPC G01B 3/04; G01B 3/004

(57) ABSTRACT

An electrical measuring device including an elongated member. The elongated member is at least 52 inches in length. There is at least one fastening strap located at a top end of the elongated member. The strap can secure the elongated member in an upright manner when not in use. There is a plurality of indicia located on the elongated member. The indicia display various measurements that correspond to specific heights of electrical implements. Specifically, the indicia specify heights for outlets and switches. The elongated member can further have various colors disposed thereon. The colors align with the different indicia.

### CROSS REFERENCE TO RELATED APPLICATIONS

This application claims the benefit of U.S. Provisional Application No. 62/736,524 filed on Sep. 26, 2018. The above identified patent application is herein incorporated by reference in its entirety to provide continuity of disclosure.

### BACKGROUND OF THE INVENTION

The present invention relates to an electrical measuring device. More particularly, the present invention provides a device that will allow an electrician to easily measure where to place outlets and switches.

Many electricians and contractors constantly find themselves in a position where they need to accurately measure an item. Many times, if the measurements are not exact, items may be placed wrong place. If an outlet or switch is not placed at the correct height, it could interfere with other electrical faculties. Further, if an electrical box is not located in the right area, a home or office could fail inspection. This can cause a delay in the sale or opening of a home or business. This can be a costly mistake and one that should be avoided at all cost. In order to fix such a mistake, the outlet or switch could need to be removed and replaced. This means that the device may have to be cut from a wall, the wall replaced, and the device put back in.

It can be difficult to accurately measure things. When working on a job, even when measured twice, things can be mis-measured and misplaced. Traditional measuring tapes can be difficult to use and can frequently lead to the wrong distances being taken. This can lead to many issues. It is important in construction to have the ability to accurately measure.

Consequently, there is a need in for an improvement in the art of properly placing outlets and switches at the correct heights. The present invention substantially diverges in design elements from the known art while at the same time solves a problem many people face when properly measuring for outlets and switches. In this regard the present invention substantially fulfills these needs.

### SUMMARY OF THE INVENTION

The present invention provides an electrical measuring device wherein the same can be utilized for providing convenience for the user when installing outlets and switches. The present system comprises an elongated member. The elongated member further comprises a securing loop disposed at one end. Indicia is disposed on the elongated member corresponding to specific measurements.

Another object of the present invention is a system comprising an elongated member. The elongated member includes a plurality of securing loops disposed at one end. Indicia is disposed on the elongated member corresponding to specific measurements.

Another object of the present invention is to provide a first indicia corresponding to 12 inches, wherein the indicia further displays the term wall outlet.

Another object of the present invention is to provide a second indicia corresponding to 16 inches, wherein the indicia further displays the term bedroom outlet.

Another object of the present invention is to provide a third indicia corresponding to 48 inches, wherein the indicia further displays the term kitchen outlet, bath G.F.I. and handicap outlet.

Another object of the present invention is to provide a fourth indicia corresponding to 52 inches, wherein the indicia further displays the term switch box.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of several embodiments of the electrical measurement tool.

FIG. 2 shows a close-up view of several embodiments of the electrical measurement tool having at least one securing strap.

FIG. 3 shows a close-up view of several embodiments of the electrical measurement tool that has raised sections corresponding to the heights.

FIG. 4 shows a side view showing the indicia located on an embodiment of the electrical measuring stick.

FIG. 5 shows a perspective view of an embodiment of the electrical measurement tool that can fold to a flat position.

### DETAILED DESCRIPTION OF THE INVENTION

Reference is made herein to the attached drawings. Like reference numerals are used throughout the drawings to depict like or similar elements of the electrical measurement device. For the purposes of presenting a brief and clear description of the present invention, a preferred embodiment will be discussed as used for measuring heights for outlets and switches. The figures are intended for representative purposes only and should not be considered to be limiting in any respect.

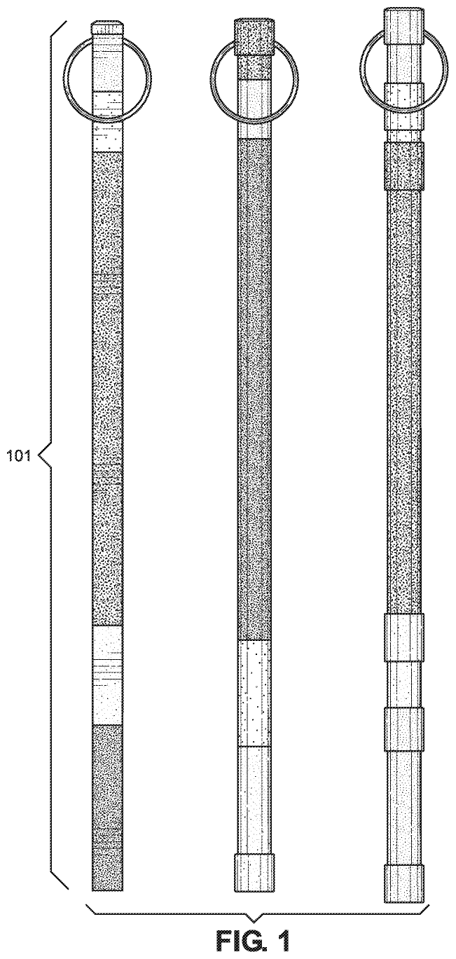

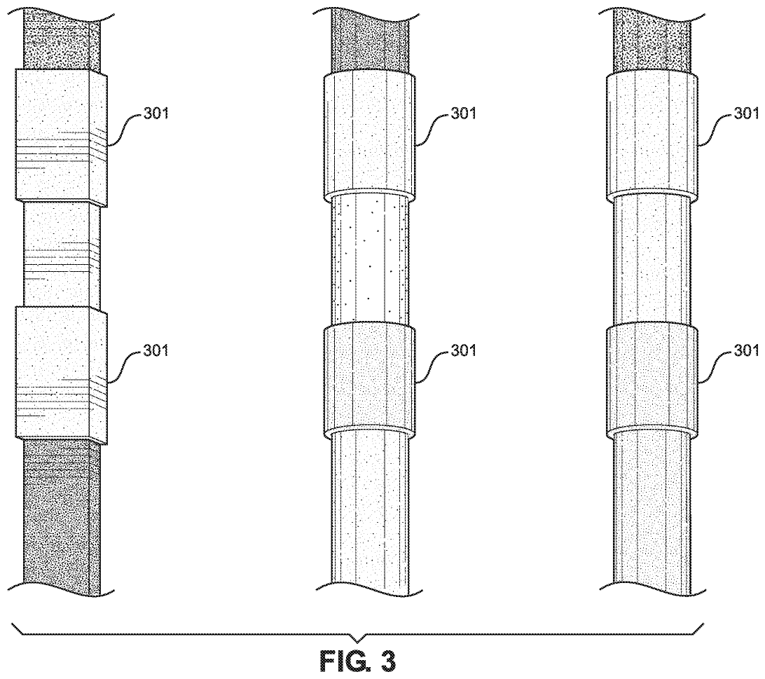

Referring now to FIG. 1, there is shown a perspective view of an embodiment of the electrical measurement tool. The electrical measurement tool has an elongated member 101. This elongated member 101 is at least 52 inches in length. In one embodiment, the elongated member 101 is longer than 52 inches. In one embodiment, the elongated member 101 is rectangular. In one embodiment, the elongated member 101 is cylindrical. The elongated member 101 further comprises a plurality of indicia thereon. The indicia correspond to specific measurements as shown by FIG. 3. In one embodiment, the electrical measurement tool is has a plurality of colors thereon. The colors correspond to the different indicia on the elongated member 101.

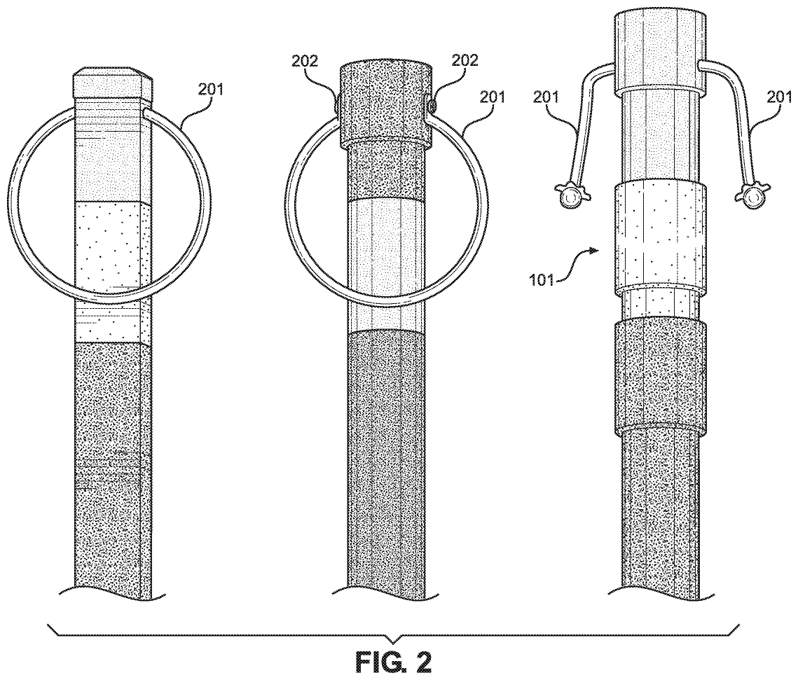

Referring now to FIG. 2, there is shown a close-up view of an embodiment of the electrical measurement tool having at least on securing strap. The elongated member 101 has at least one securing strap 201 attached thereto. In one embodiment, the securing strap 201 is a wire strap. This will allow the strap to be bent and hold a shape. In another embodiment the securing strap 201 can be made from metal. This will allow the securing strap 201 to maintain its shape. In one embodiment, the securing strap 201 is made from a rope. This will allow the securing strap to be tied to an item.

The securing strap 201 is connected to the elongated member such that it is able to rotate and can be moved as needed. In one embodiment, the securing strap 201 is connected to the elongated member 101 through a hole located in an upper end thereof. In one of these embodiments a rope is placed through the hole. The rope will then have enlarged ends caused by knots. In one embodiment there are stoppers placed on the ends of the rope that will prevent it from moving back through the hole.

In another embodiment the securing strap 201 is a solid securing strap and is connected by being placed through the hole and bent together. This will ensure that the securing strap cannot exit the hole. In one embodiment, the securing strap 201 is connected via a fastener 202. The fastener will connect the securing strap 201 to the elongated member 101 while still allowing the securing strap to rotate.

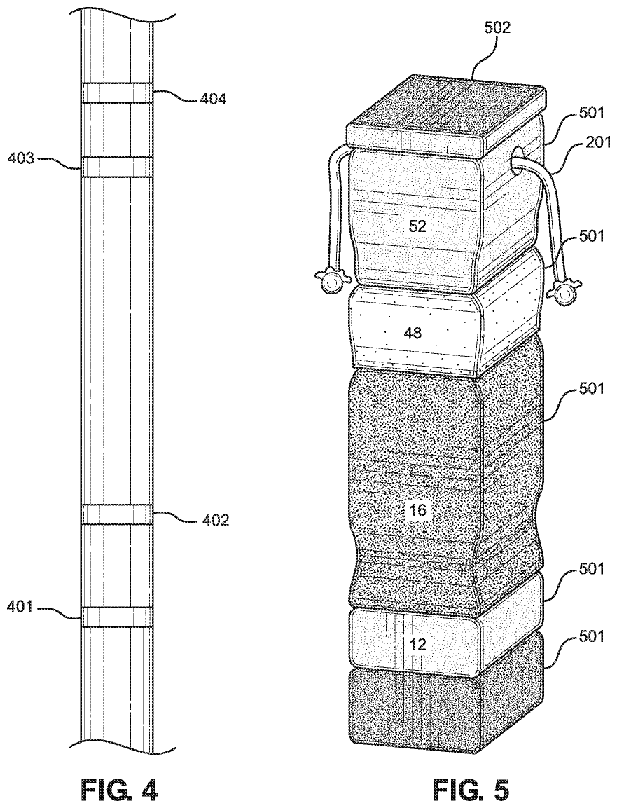

Referring now to FIG. 3, there is shown a close-up view of an embodiment of the electrical measurement tool that has raised sections corresponding to distinct heights. In an embodiment of the electrical measurement tool, there are raised sections 301 that correspond to the specific heights and measurements. The raised sections 301 are placed on the electrical measurement tool such that an end of the raise sections will correspond with a desired height for an electrical implement as described in FIG. 4. In one embodiment the raise sections 301 have flat edges. This will allow the raised sections 301 to allow for marking a wall or other item to allow for proper measuring. In one embodiment, the raised sections 301 have the indicia thereon. In another embodiment, the indicia are located under the raised sections 301.

Referring now to FIG. 4, there is shown a side view showing the indicia located on an embodiment of the electrical measuring tool. In one embodiment of the electrical measuring tool, there are 4 indicia located thereon. The first indicia 401 reads “12 inch bedroom outlet.” The second indicia 402 reads “16 inch living room outlet.” The third indicia 403 reads “48 inch kitchen outlet bathroom G.F.I. Handicap outlet.” The fourth indicia 404 reads “52 inch switch box.” In other embodiments, other indicia can be placed thereon.

Referring now to FIG. 5, there is shown a perspective view of an embodiment of the electrical measurement tool that can fold to a flat position. In one embodiment, the elongated member 101 is made from a plurality of fabric sections 501. The fabric sections are sewn together such that they will form the elongated member. In one embodiment, the plurality of fabric sections 501 are different colors. In one embodiment, the different colors will correspond to the different indicia and measurements.

In this embodiment there is a top section 502. That is attached to the top fabric section. In one embodiment, the top section 502 is solid. This will provide structure to the elongated member. In another embodiment the top section 502 will have an internal frame. This internal frame will still provide structure but will reduce weight. There is at least one securing strap 201 located in an upper portion of fabric sections 501. The securing strap 201 is located through a plurality of apertures in the fabric. In one embodiment, the securing strap 201 is a length of cord. The securing strap 201 will allow for the fabric sections to be bunched together and held in a collapsed storage position. This will allow the electrical measuring device to be stored flat and extended for use. In another embodiment the bottom of the elongated member is weighted. This help prevent the device from swaying and ensure that it is properly extended to the right measurements.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An electrical measuring device, comprising:
an elongated member;
the elongated member having a securing loop disposed at one end;
indicia on the elongated member corresponding specific measurements.

2) The electrical measuring device of claim 1, wherein a first indicia corresponds to 12 inches;
the indicia further displays the term wall outlet.

3) The electrical measuring device of claim 1, wherein a second indicia corresponds to 16 inches;
the indicia further displays the term bedroom outlet

4) The electrical measuring device of claim 1, wherein a third indicia corresponds to 48 inches;
the indicia further displays the term kitchen outlet, bath G.F.I. and handicap outlet.

5) The electrical measuring device of claim 1, wherein a forth indicia corresponds to 52 inches;
the indicia further displays the term switch box.

6) The electrical measuring device of claim 1, wherein each measurement corresponds to a unique color on the device.

7) An electrical measuring device, comprising:
an elongated member;
wherein the elongated member comprises a plurality of securing loops disposed at one end thereof;
indicia disposed on the elongated member corresponding specific measurements.

8) The electrical measuring device of claim 7, wherein a first indicia corresponds to 12 inches;
the indicia further displays the term wall outlet.

9) The electrical measuring device of claim 7, wherein a second indicia corresponds to 16 inches;
the indicia further displays the term bedroom outlet.

10) The electrical measuring device of claim 7, wherein a third indicia corresponds to 48 inches;
the indicia further displays the term kitchen outlet, Bath G.F.I. and Handicap outlet.

11) The electrical measuring device of claim 7, wherein a forth indicia corresponds to 52 inches;
the indicia further displays the term switch box.

12) The electrical measuring device of claim 7, wherein there is a plurality of colors that correspond to different measurements.

13) An electrical measuring device, comprising:
an elongated member;
the elongated member having a securing loop disposed at one end;
indicia on the elongated member corresponding specific measurements, wherein a unique color will represent each different measurement.

14) The electrical measuring device of claim 13, further comprising multiple securing loops.

15) The electrical measuring device of claim 13, wherein the elongated body is made from a plurality of fabric sections and each section is uniquely colored to represent a different specific measurement.

16) The electrical measuring device of claim 13, wherein a top section provides structure to the elongated body have having a ridged internal frame.

17) The electrical measuring device of claim 13, wherein the securing strap is a rope.

18) The electrical measuring device of claim 13, further comprising a weight located within the bottom of the elongated body.
